(19) United States
(12) Patent Application Publication
(10) Pub. No.: US 2022/0333908 A1
(43) Pub. Date: Oct. 20, 2022

(54) Fish-R Rul-R

(71) Applicant: Joseph Bryan, Flagler Beach, FL (US)

(72) Inventor: Joseph Bryan, Flagler Beach, FL (US)

(21) Appl. No.: 17/234,721

(22) Filed: Apr. 19, 2021

(51) Int. Cl. G01B 3/02; A01K 97/00

(52) U.S. Cl. CPC G01B 3/02; A01K 97/00

(57) ABSTRACT

An article of manufacture for providing a region- and species-specific fish-measuring device with fish catch or release rules is disclosed. The article has a base member having a top surface and a first end, a starting end surface member coupled to the first end of the base member, and a measuring ruler along the top surface of the base member. The starting end surface member extending upward perpendicular to the top surface of the base member. The measuring ruler having a measuring starting position from the starting end surface member, a plurality of measuring sections, and a legend. The plurality of measuring sections each contain one or more graphic representations of fish species legal to keep when a measured fish is at least as long as the measuring section fish species to which the measured fish belongs.

### TECHNICAL FIELD

This application relates in general to an article of manufacture for providing a fishing aid, and more specifically, to an article of manufacture for a region- and species-specific fish-measuring device with fish catch or release rules.

### BACKGROUND

Fishermen and women who catch various species of fish need to ensure that any fish that are kept and not released are of legal size for the region or specific body of water in which the fishing takes place. The species available in some waters are not always available in other regions or bodies of water. Additionally, the rules for a minimum size for various species may vary for waters in different states containing the same body of water. For example, the rules for catching and keeping rockfish caught in the Chesapeake Bay may be different for fish caught in the upper part of the bay in Maryland as compared to the lower part of the bay in Virginia. Knowing all of the possible species and rules for these various regions and bodies of water requires some effort. Additionally, the information needs to be available when and where a particular fish is being measured to determine whether or not the fish should be caught or released back into the water.

Therefore, a need exists for a an article of manufacture for providing a region- and species-specific fish-measuring device with fish catch or release rules. The present invention attempts to address the limitations and deficiencies in prior solutions according to the principles and example embodiments disclosed herein.

### SUMMARY

In accordance with the present invention, the above and other problems are solved by providing an article of manufacture for a region- and species-specific fish-measuring device with fish catch or release rules according to the principles and example embodiments disclosed herein.

In one embodiment, the present invention is an article of manufacture for providing a region- and species-specific fish-measuring device with fish catch or release rules. The article has a base member having a top surface and a first end, a starting end surface member coupled to the first end of the base member, and a measuring ruler along the top surface of the base member. The starting end surface member extending upward perpendicular to the top surface of the base member. The measuring ruler having a measuring starting position from the starting end surface member, a plurality of measuring sections, and a legend. The plurality of measuring sections each contain one or more graphic representations of fish species legal to keep when a measured fish is at least as long as the measuring section fish species to which the measured fish belongs.

In another aspect of the present disclosure, the starting end surface member comprises a starting measuring surface, a top surface, and a center mark on the top surface indicating a centerline of the measuring ruler.

In another aspect of the present disclosure, the plurality of measuring sections comprise one or more of the following: a 10 inch section, an 11 inch section, a 12 inch section, a 13 inch section, a 14 inch section, a 15 inch section, a 16 inch section, a 17 inch section, an 18 inch section, a 19 inch section, a 20 inch section, a 24 inch section, a 27 inch section, a 28 inch section, a 30 inch section, a 32 inch section and a 33 inch section.

In another aspect of the present disclosure, the base member and the starting end surface member are made of aluminum.

In another aspect of the present disclosure, the measuring ruler comprises a vinyl graphic image affixed to the top surface of the base member, the vinyl graphic image illustrating a starting point for the measuring ruler adjacent to the starting end surface member.

In another aspect of the present disclosure, the one or more graphic representations of fish species illustrates the fish species from a geographic region comprising: the Atlantic coast of Florida, the Gulf of Mexico, the Chesapeake Bay, the Mid-Atlantic and New England ocean coastlines, the Great Lakes, the Minnesota Lakes, the San Francisco Bay, the Southern California ocean coastline, and the Puget Sound.

In another aspect of the present disclosure, the geographic region corresponds to the Atlantic coast of Florida.

In another aspect of the present disclosure, the one or more graphic representations of fish species of the 8 inch section comprises Lane Snapper, the one or more graphic representations of fish species of the 10 inch section comprises Mangrove, Bigeye, and Schoolmaster, the one or more graphic representations of fish species of the 11 inch section comprise Permit and Pompano, the one or more graphic representations of fish species of the 12 inch section comprise Flounder, Yellowtail, Vermillion, Trigger, Sheephead and Spanish Mac, the one or more graphic representations of fish species of the 14 inch section comprise Drum “Min” and Red Porgy, the one or more graphic representations of fish species of the 15 inch section comprises Spotted Trout “Min”, the one or more graphic representations of fish species of the 16 inch section comprises Hogfish, the one or more graphic representations of fish species of the 18 inch section comprise Redfish, Mutton, and Trippletail, the one or more graphic representations of fish species of the 19 inch section comprise Spotted Tail “Max”, the one or more graphic representations of fish species of the 20 inch section comprise Red Snapper, Dolphin “Fork”, and Red Grouper, the one or more graphic representations of fish species of the 24 inch section comprise Drum “Max”, African Pompano, King Mackerel, Snowy Grouper, Gag Grouper, and Black Grouper, the one or more graphic representations of fish species of the 27 inch section comprise Redfish “Max” and Yellow Tuna, the one or more graphic representations of fish species of the 28 inch section comprise Snook and Greater Amberjack, the one or more graphic representations of fish species of the 32 inch section comprise Cero and Snook “Max”, and the one or more graphic representations of fish species of the 33 inch section comprises Cobia “Fork”.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture providing a region- and species-specific fish-measuring device with fish catch or release rules according to the present invention.

FIG. 2 illustrates another view of an article of manufacture of an article of manufacture providing a region- and species-specific fish-measuring device with fish catch or release rules according to the present invention.

FIG. 3a-c illustrates multiple views of a partial set of fish images providing a region- and species-specific fish-measuring device with fish catch or release rules according to the present invention.

FIG. 4 illustrates a portion of the measuring devices having dividing tick marks according to the present invention.

FIG. 5 illustrates an example Legend portion of the measuring device according to the present invention.

### DETAILED DESCRIPTION

This application relates in general to an article of manufacture for providing a fishing aid, and more specifically, to an article of manufacture for providing a region- and species-specific fish-measuring device with fish catch or release rules according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “fisherman,” and “user” refer to an entity, e.g. a human, using the region- and species-specific fish-measuring device with fish catch or release rules associated with the invention. The term user herein refers to one or more users.

The term “invention” or “present invention” refers to the invention being applied for via the patent application with the title “Fish-R Rul-R.” Invention may be used interchangeably with fishing ruler.

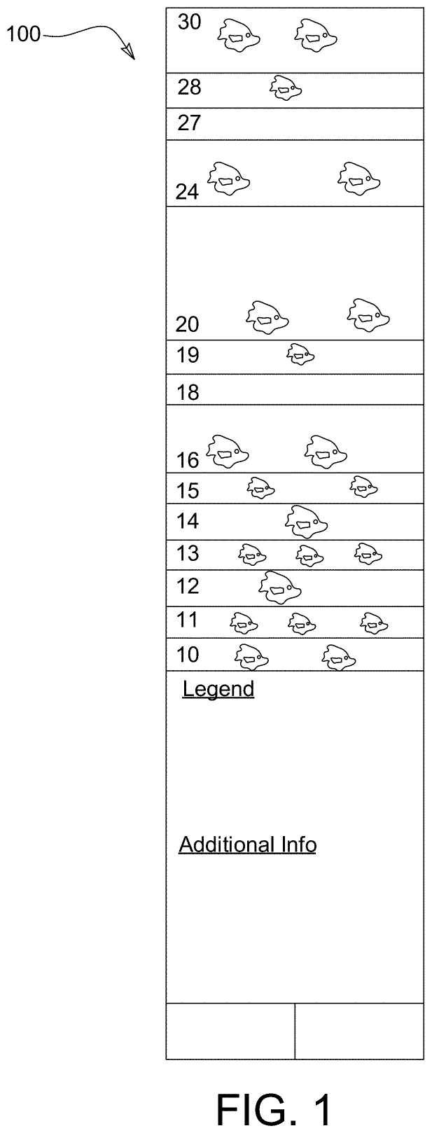

In general, the present disclosure relates to an article of manufacture for providing a fishing aid. To better understand the present invention, FIG. 1 illustrates an example embodiment of an article of manufacture for providing a region- and species-specific fish-measuring device with fish catch or release rules according to the present invention.

The measuring device 100 has a top surface and a first end and is 35.5 inches long and 5.5 inches wide constructed of a composite material sandwiched in aluminum. The measuring device 100 comprises a base member 101, a starting end surface 102, and a measuring ruler 103 starting at 0″ adjacent to the starting end surface member 102 and extending the length of the base member 101. The starting end surface member 102 is coupled to a first end of the base member 101 and extends upward to the base member 101 perpendicular to the measuring ruler 103. A center mark 104 is inscribed along a top surface of the starting end surface member 102 indicating a centerline of the measuring ruler 103.

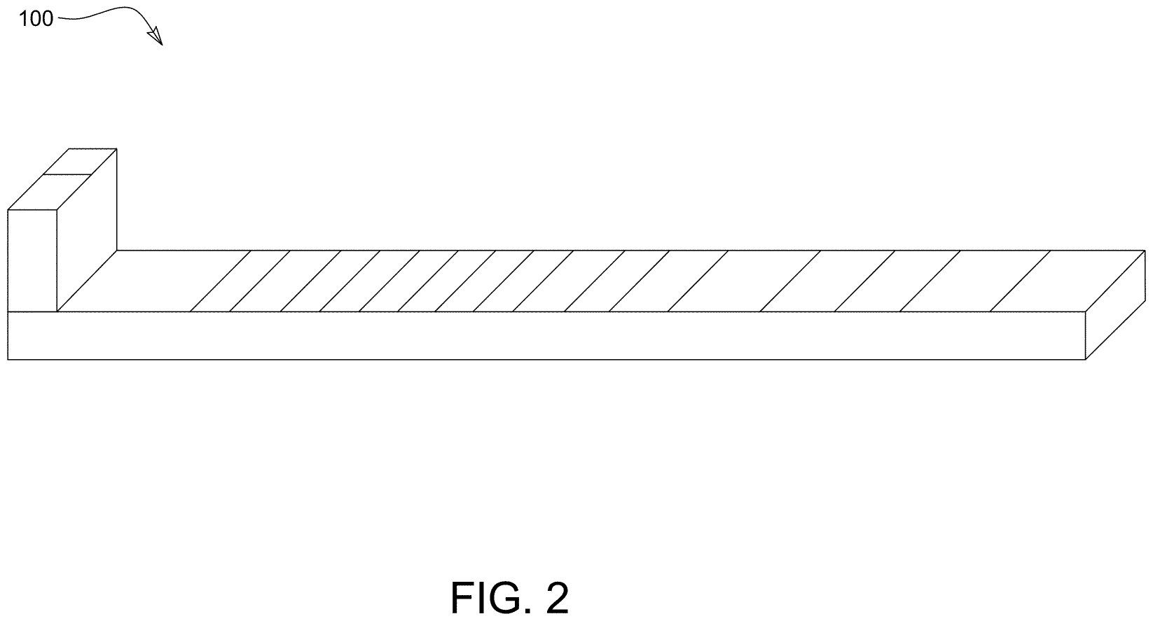

FIG. 2 illustrates another view of an article of manufacture of an article of manufacture providing a region- and species-specific fish-measuring device with fish catch or release rules according to the present invention. The top surface 201 of the base member 101 of the measuring device 100 is covered in a water-resistant type of vinyl with color photos of various species of fish in the Atlantic Ocean and Gulf waters of Florida, but can be used in other parts of the country once patterned for each respective state and region's common fish species and state and federal laws. Other embodiments may be made in a similar manner identifying species in other parts of the United States to include states and lakes. The vinyl print not only contains the various species of fish, but is also used as a measuring device to determine the length of fish. The chart lists specific rules which apply within the respective waters the fish are caught such as bag limit per person and vessel and aggregate number and other useful state and federal rules which apply and are covered in the state and local guide brochures and websites.

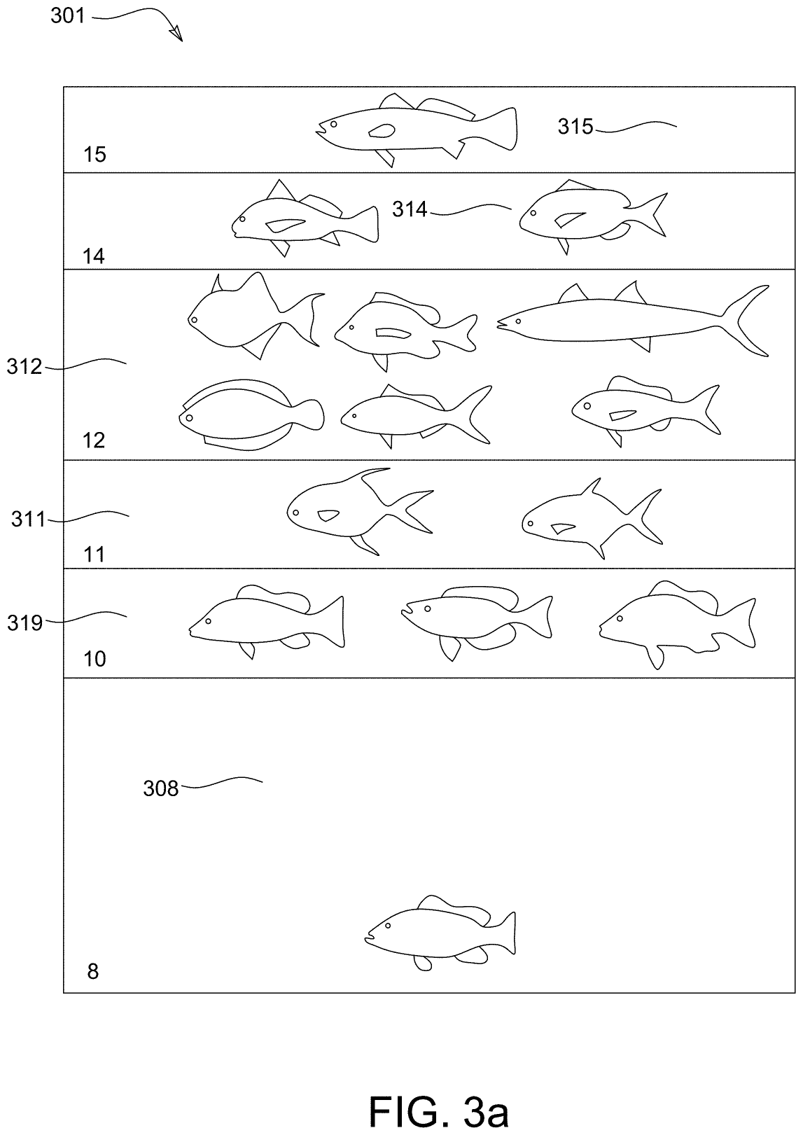

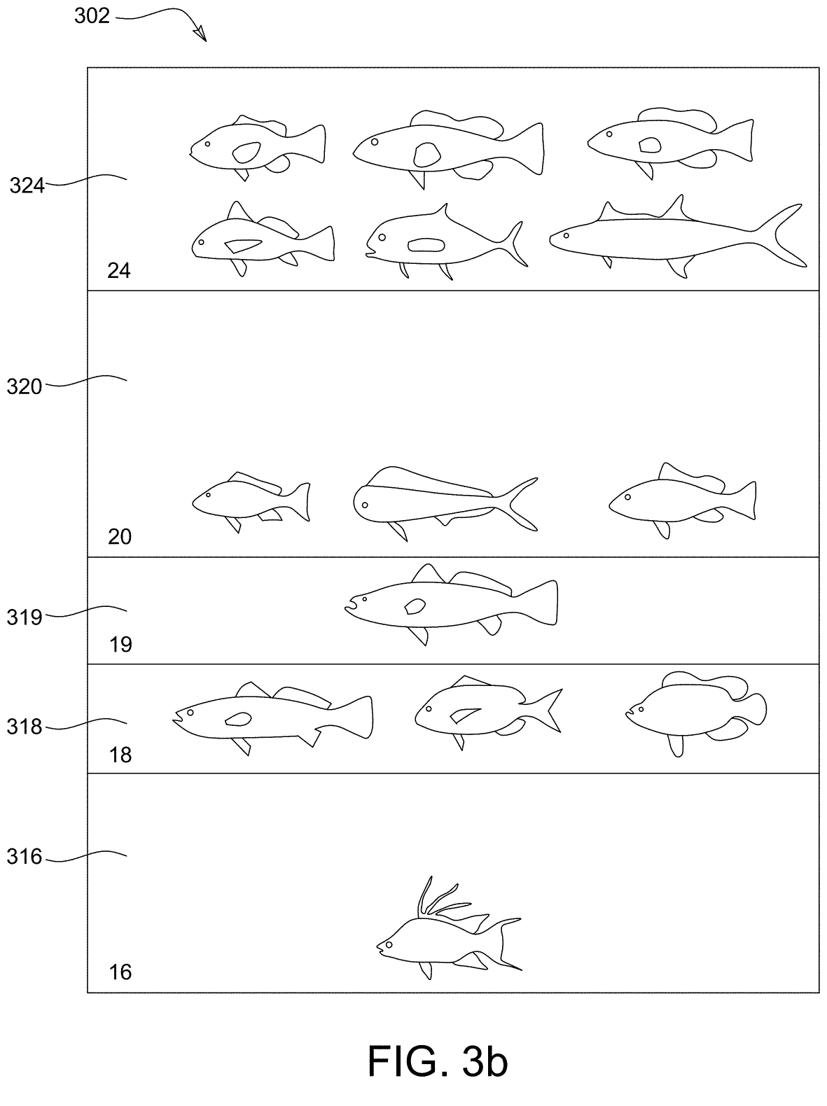

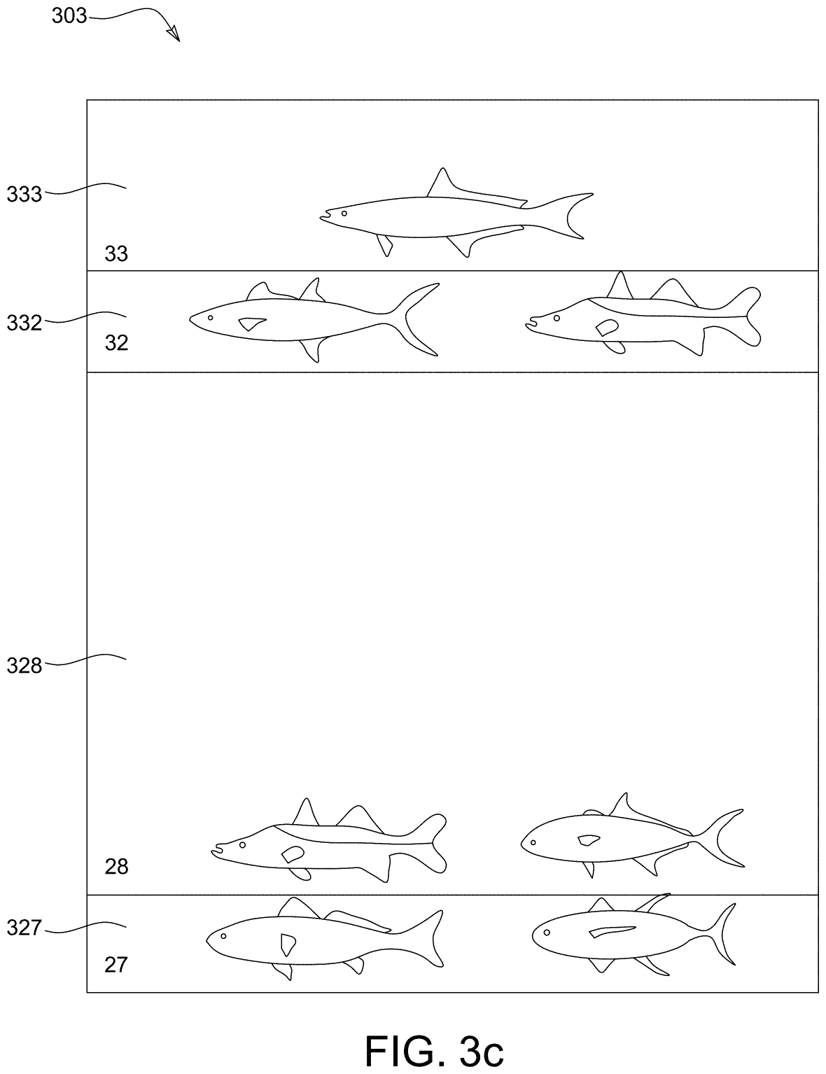

In one embodiment, the fishing ruler 100 has been created illustrating ocean and gulf fish available off of the coast of Florida. FIG. 3a-c illustrates multiple views of a partial set of fish images providing a region- and species-specific fish-measuring device listed below in Table 1. In this embodiment, the fishing ruler 100 presents the following species of fish off the Florida Coast along with a legal size as shown in Table 1:

TABLE 1
Florida Atlantic and Gulf Coast

| Size in Inches | Species |
|---|---|
| 8 | Lane Snapper |
| 10 | Mangrove |
| | Bigeye and |
| | Schoolmaster |
| 11 | Permit and |
| | Pompano |
| 12 | Flounder |
| | Yellowtail |
| | Vermillion |
| | Trigger |
| | Sheephead and |
| | Spanish Mac |
| 14 | Drum “Min” and |
| | Red Porgy |
| 15 | Spotted Trout “Min” |
| 16 | Hogfish |
| 18 | Redfish |
| | Mutton and |
| | Trippletail |
| 19 | Spotted Tail “Max” |
| 20 | Red Snapper |
| | Dolphin “Fork” and |
| | Red Grouper |
| 24 | Drum “Max” |
| | African Pompano |
| | King Mackerel |
| | Snowy Grouper |
| | Gag Grouper and |
| | Black Grouper |
| 27 | Redfish “Max” and |
| | Yellow Tuna |
| 28 | Snook and |
| | Greater Amberjack |
| 32 | Cero and |
| | Snook “Max” |
| 33 | Cobia “Fork” |

In a second embodiment, the fishing ruler 100 presents the following species of fish off the South Carolina Atlantic Coast along with a legal size as shown in Table 2:

TABLE 2
South Carolina Atlantic Coast

| Size in Inches | Species |
|---|---|
| 12 | Spanish Mackerel, 3 pp, B (bag limit per day) |
| | Weakfish, 1 pp, B (bag limit per day) |
| 13 | |
| 14 | Spotted Seatrout, 10 pp, B (per day) , SS |
| | Sheepshead, 10 pp, not > 30 PB daily |
| 14-27 | Black Drum 5 pp |
| 15 | Flounder, 10 pp, not > 20, PB |
| 15-23 | Red Drum, 2 pp, Not > 6 PB, SS |
| 18 | Tripletail, 3 pp, B (bag limit per day), not > 9 |
| 19 | |
| 20 | Dolphin, 10 pp, B (bag limit per day) |
| 24 | King Mackerel, 3 pp |
| 26 | Striped Bass, 3 pp, SS, SPZ |
| 27 | Hybrid Bass, White Bass & Combination, 2 pp, SPZ |
| | Atlantic Croaker, Spot, Whiting, 50 pp, PD, A |
| | Wahoo, 2 pp, PD |
| 36 | Cobia, 1 pp B (per day) 5, SPZ, SS |
| 77 | Tarpon, 1 pp, PD |
| NO SIZE | American Shad, 10 pp, SPZ |
| LIMIT | Herring, 1 bushel pp, PD, SPZ |
| | Bluefish, 3 pp, PD |
| | Saltwater Catfish, POSSESSION PROHIBITED |

FIG. 2 illustrates another view of an article of manufacture for providing a region- and species-specific fish-measuring device with fish catch or release rules according to the present invention. The device also has a ½″×2.25′×5.5″ PVC backer block with a 1.5″ cut in the center used to guide the fish's head with the fishing line attached to the end of the device and enables the fish to be laid onto the ruler to the specific measured line to determine its legal limit to be kept or released safely.

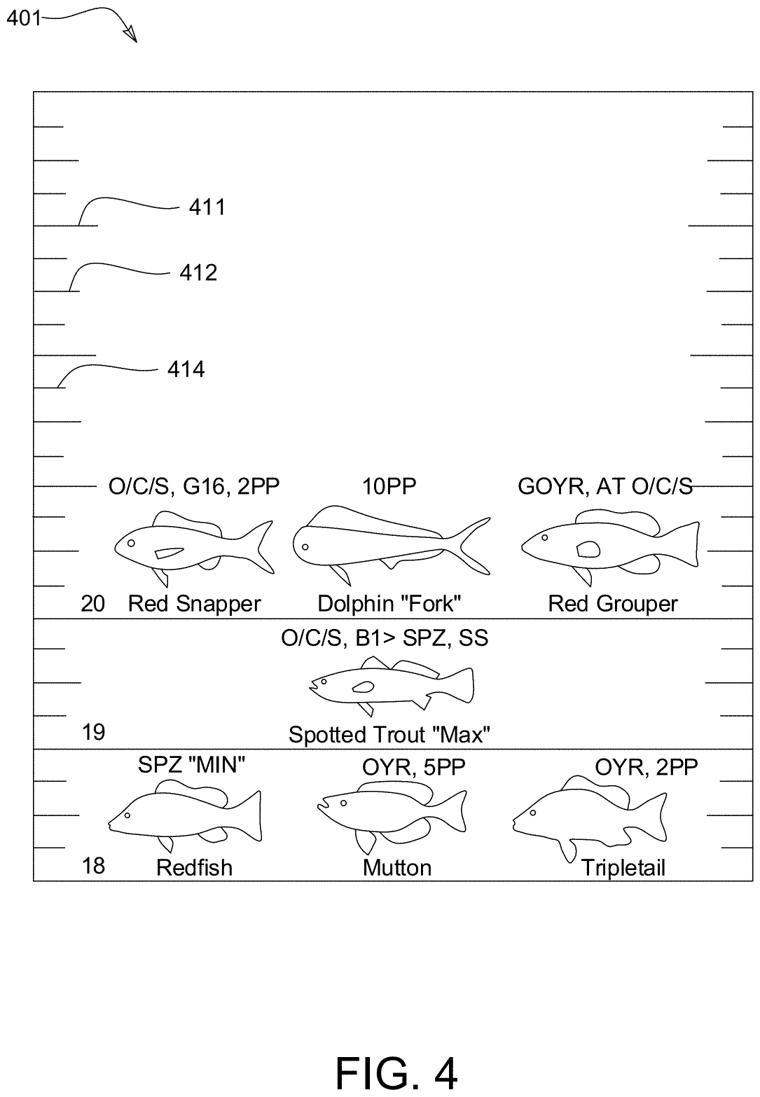

FIG. 4 illustrates a portion of the measuring devices having dividing tick marks according to the present invention. A portion of the measuring device 401 between 18″ to 24″ sections are shown having their respective fish species. Tick marks 411-413 are shown dividing each of the 18″ 418, 19″ 410, and 20″ 420 sections. These tick marks include inch dividing lines 411, one-half inch dividing lines 412, and one-quarter inch dividing lines 413. These tick marks 411-413 may be included in each of the sections of the measuring device 100. Additionally, the example embodiment of FIG. 4 show measuring tick mark 411-413 in inches while one of ordinary skill will recognize that the measuring tick mark 411-413 may also be in centimeters and millimeters without deviating from the present invention.

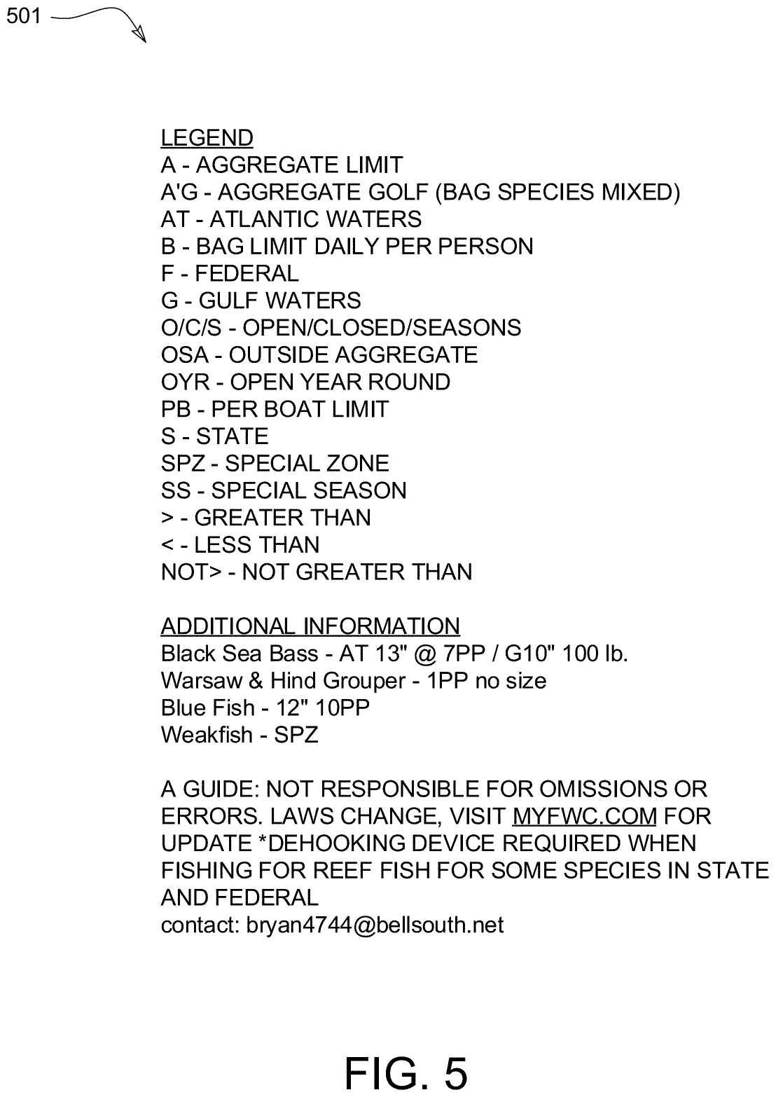

FIG. 5 illustrates an example Legend portion of the measuring device according to the present invention. A legend 501 for the specific set of fish species for a particular region or body of water may be provided as part of the fishing ruler 100. The legend 501 includes:

A—Aggregate Limit

A/G—Aggregate Gold Bag Species

AT—Atlantic Waters

B—Bag Limit Daily Per Person

F—Federal

G—Gulf Waters

O/C/S—Open/Closed/Season

OSA—Outside Aggregate

OYR—Open Year Round

PB—Per Boat Limit

PP—Per Person Limit

S—State

SPZ—Special Zone

SS—Special Season

>—Greater Than

<—Less Than

Other useful information 103 regarding fishing in a particular region or body of water also may be listed on the fishing ruler 100 as may fit within the available space. This other information 103 may include:

ADDITIONAL INFORMATION

Black Sea Bass AT 33″ @ 7 PP/.???

Warsaw & Hind Grouper—5 PP no-time

Blue Fish—13″ 10 PP

Weak Fish—SPZ

While the above set of fish species and their corresponding legal length to be kept by a fisherman are representative of fish species available in the waters off of the State of Florida, the fishing ruler 100 also may be made with a different set of fish species and legal sizes for a particular geographical region including the Chesapeake Bay, the Mid-Atlantic and New England ocean coastlines, the Great Lakes, the Minnesota Lakes, the San Francisco Bay, the Southern California ocean coastline, and the Puget Sound, among other bodies of water including inland rivers.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing a region- and species-specific fish-measuring device with fish catch or release rules, the article comprises:
a base member having a top surface and a first end;
a starting end surface member coupled to the first end of the base member, the starting end surface member extending upward perpendicular to the top surface of the base member; and
a measuring ruler along the top surface of the base member, the measuring ruler having a measuring starting position from the starting end surface member. a plurality of measuring sections, and a legend;
wherein the plurality of measuring sections each contain one or more graphic representations of fish species legal to keep when a measured fish is at least as long as the measuring section fish species to which the measured fish belongs.

2. The article of manufacture according to claim 1, wherein the starting end surface member comprises a starting measuring surface, a top surface, and a center mark on the top surface indicating a centerline of the measuring ruler.

3. The article of manufacture according to claim 1, wherein the plurality of measuring sections comprise one or more of the following: a 10 inch section, an 11 inch section, a 12 inch section, a 13 inch section, a 14 inch section, a 15 inch section, a 16 inch section, a 17 inch section, an 18 inch section, a 19 inch section, a 20 inch section, a 24 inch section, a 27 inch section, a 28 inch section, a 30 inch section, a 32 inch section and a 33 inch section.

4. The article of manufacture according to claim 1, wherein the base member and the starting end surface member are made of aluminum.

5. The article of manufacture according to claim 1, wherein the measuring ruler comprises a vinyl graphic image affixed to the top surface of the base member, the vinyl graphic image illustrating a starting point for the measuring ruler adjacent to the starting end surface member.

6. The article of manufacture according to claim 3, wherein the one or more graphic representations of fish species illustrates the fish species from a geographic region comprising: the Atlantic coast of Florida, the Gulf of Mexico, the Chesapeake Bay, the Mid-Atlantic and New England ocean coastlines, the Great Lakes, the Minnesota Lakes, the San Francisco Bay, the Southern California ocean coastline, and the Puget Sound.

7. The article of manufacture according to claim 6, wherein the geographic region corresponds to the Atlantic coast of Florida.

8. The article of manufacture according to claim 7, wherein
the one or more graphic representations of fish species of the 8 inch section comprises Lane Snapper;
the one or more graphic representations of fish species of the 10 inch section comprises Mangrove, Bigeye, and Schoolmaster;
the one or more graphic representations of fish species of the 11 inch section comprise Permit and Pompano;
the one or more graphic representations of fish species of the 12 inch section comprise Flounder, Yellowtail, Vermillion, Trigger, Sheephead and Spanish Mac;
the one or more graphic representations of fish species of the 14 inch section comprise Drum “Min” and Red Porgy;
the one or more graphic representations of fish species of the 15 inch section comprises Spotted Trout “Min”;
the one or more graphic representations of fish species of the 16 inch section comprises Hogfish;
the one or more graphic representations of fish species of the 18 inch section comprise Redfish, Mutton, and Trippletail;
the one or more graphic representations of fish species of the 19 inch section comprise Spotted Tail “Max”;
the one or more graphic representations of fish species of the 20 inch section comprise Red Snapper, Dolphin “Fork”, and Red Grouper
the one or more graphic representations of fish species of the 24 inch section comprise Drum “Max”, African Pompano, King Mackerel, Snowy Grouper, Gag Grouper, and Black Grouper;
the one or more graphic representations of fish species of the 27 inch section comprise Redfish “Max” and Yellow Tuna;
the one or more graphic representations of fish species of the 28 inch section comprise Snook and Greater Amberjack;
the one or more graphic representations of fish species of the 32 inch section comprise Cero and Snook “Max”; and
the one or more graphic representations of fish species of the 33 inch section comprises Cobia “Fork”.
